(19) United States
(12) Patent Application Publication
(10) Pub. No.: US 2006/0051445 A1
(43) Pub. Date: Mar. 9, 2006

(54) Injection molding system, apparatus, method and quick-connect mechanism

(76) Inventors: Sten Rundberg, Malmo (SE); Ismo Nieminen, Kristianstad (SE); Jonas Castman, Kristianstad (SE); Michael D. Ringer, SR., Leominster, MA (US)

Correspondence Address: Jeffrey T. Klayman;Bromberg & Sunstein LLP, 125 Summer Street, Boston, MA, 02110-1618, US

(21) Appl. No.: 10/934,088

(22) Filed: Sep. 3, 2004

(51) Int. Cl. B29C 45/04

(52) U.S. Cl. 425/190

(57) ABSTRACT

An injection molding system utilizes pre-assembled modular molds. The molds interface with an injection molding machine through standardized injection and ejection interfaces. A standardized runner clamp plate and ejector clamp plate may be integral to the injection molding machine or attached to the injection molding machine for interfacing the mold to the injection molding machine. A quick-connect mechanism may be used to couple an active ejection mechanism in the injection molding machine with integral ejector components in the mold.

### FIELD OF THE INVENTION

The present invention relates generally to injection molding, and more particularly to injection molding systems using pre-assembled molds that can be installed into a standardized, reusable mold base.

### BACKGROUND OF THE INVENTION

In a typical injection molding system, one or more materials (such as molten plastic or metal) are injected into a mold in order to form a molded part. The mold includes one or more molding chambers for receiving the injected material(s). After a material is injected, the material is typically allowed to set for some period of time, after which another material may be injected. When the molded part is complete, the molded part is ejected from the mold, for example, by externally actuating various ejector components that are built into the mold.

Thus, an injection molding machine typically includes at least an injection mechanism for causing injection of one or more materials into a mold and an ejection mechanism for ejecting the molded part (e.g., by activating the ejector components in the mold). Conceptually, the mold fits into the injection molding system between the injection mechanism and the ejection mechanism.

The mold typically includes two separate sections, each defining a portion of each molding chamber. One of the mold sections may be fixedly mounted within the injection molding machine, while the other mold section is movably mounted within the injection molding machine. During molding, the two sections are typically forced into contact with one another to form the molding chamber(s), for example, by forcing the movably mounted mold section against the fixedly mounted mold section. After the mold sections are in contact, the material(s) can be injected into the molding chamber(s).

As known in the art, each of the mold sections may be composed of multiple interconnected modules. For example, as described in published PCT application number WO 03/031141 A1 (hereinafter referred to as the “Persson PCT application”), a first mold section may include a first mold module, a drive module, and a distributing module, while a second mold section may include a second mold module, an ejector module, an engaging module, and a guide module. The first mold section may be fixedly mounted within the injection molding machine and the second mold section may be movably mounted in the injection molding machine, in which case the second mold section may be moved into contact with the first mold section in order to form one or more mold chamber(s) for the injection molding process. The engaging module, together with an outer locking means, locks the second mold module against the first mold module and absorbs the forces which act to separate the first and the second mold modules from each other during the injection molding process. The guide module supports the second mold module, the ejector module, and the engaging module to ensure that they move in a suitable fashion in relation to the first mold section. Multiple-part molds are also discussed in U.S. Pat. Nos. 4,274,617; 5,837,086; and 6,652,263.

The ejection mechanism may include a replaceable ejector plate packet. Published German patent application number DE10059045 describes an injection molding machine having a replaceable ejector plate packet that is attached to a base ejector plate packet by a bolt with a flange that cooperates with a curved recess at the base of a cross-bar fitted into a slot in the base packet.

The ejection mechanism may include an actuator that is directly or indirectly coupled to the ejector components of the mold and is hydraulically operated to actuate the ejector components of the mold. In injection molding machines that do not include a hydraulically-operated actuator, the ejector components of the mold may be actuated in other ways. For example, a portion of the mold may be moved within the injection molding machine so as to engage the ejector components of the mold with an ejection actuator that is fixedly attached to the injection molding machine. Such an injection mechanism can be implemented using a HASCO(R) guided ejector pull back device (part number Z165) that is incorporated into the movable portion of the mold and a HASCO(R) ejector rod (part number Z166) that is fixedly attached to the injection molding machine. In order to eject the molded part from the mold, the movable portion of the mold may be moved so that the guided ejector pull back device engages with the ejector rod, thereby actuating the ejector components of the mold.

All of the above-referenced patents and patent applications are hereby incorporated herein by reference in their entireties.

### SUMMARY OF THE INVENTION

In accordance with one aspect of the invention, a unitary mold for an injection molding system is composed of a number of interconnected modules. Compared to the two-part mold described in the Persson PCT application, a unitary mold of the present invention does not require an engaging module, a guide module, and outer locking means in order to move and hold two mold sections together for injection molding. Furthermore, a unitary mold of the present invention is typically easy to install and remove with little tooling. Also, by pre-assembling the entire mold, all components are protected against damage, and no parts are omitted by mistake.

In accordance with another aspect of the invention there is provided an injection molding system including an injection molding machine and a modular mold that is assembled prior to installation in the injection molding machine. The injection molding machine and the mold interface through standardized injection and ejection interfaces.

The injection molding machine typically includes an active ejection mechanism. The mold typically includes integral ejector components that are actuated by the ejection mechanism. The ejection mechanism may be coupled to the integral ejector components through a quick-connect mechanism. Typically, the injection molding machine includes a first portion of the quick-connect mechanism (e.g., on an ejector clamp plate), and the mold includes a second portion of the quick-connect mechanism (e.g., on a clamping plate).

In an exemplary embodiment, the first portion of the quick-connect mechanism comprises a male part, and the second portion of the quick-connect mechanism comprises a female part that engages the male part. The female part typically includes a positive locking feature for securing the male part during deployment and retraction of the integral ejector components. The male part typically includes a floating mechanism allowing the mold to move relative to the injection molding machine when the mold is locked into the injection molding machine.

In accordance with another aspect of the invention there is provided an injection molding machine configured to receive a pre-assembled modular mold. The injection molding machine and the mold interface through standardized injection and ejection interfaces.

The injection molding machine typically includes an active ejection mechanism that is coupled to integral ejector components in the mold through a quick-connect mechanism. Typically, the injection molding machine includes a first portion of the quick-connect mechanism (e.g., on an ejector clamp plate), and the mold includes a second portion of the quick-connect mechanism (e.g., on a clamping plate).

In an exemplary embodiment, the first portion of the quick-connect mechanism comprises a male part, and the second portion of the quick-connect mechanism comprises a female part that engages the male part. The female part typically includes a positive locking feature for securing the male part during deployment and retraction of the integral ejector components. The male part typically includes a floating mechanism allowing the mold to move relative to the injection molding machine when the mold is locked into the injection molding machine.

In accordance with another aspect of the invention there is provided apparatus in the form of a plate that is attachable to an injection molding machine for interfacing the injection molding machine with a pre-assembled modular mold. The plate and the mold interface through a standardized ejection interface. The standardized ejection interface may include a quick-connect mechanism for coupling an active ejection mechanism of the injection molding machine with integral injector components in the mold. The plate includes a first portion of the quick-connect mechanism for cooperation with a second portion of the quick-connect mechanism in the mold.

In an exemplary embodiment, the first portion of the quick-connect mechanism comprises a male part, and the second portion of the quick-connect mechanism comprises a female part that engages the male part. The male part is positively locked into the female part for deployment and retraction of the integral ejector components. The male part typically includes a floating mechanism allowing the mold to move relative to the injection molding machine when the mold is locked into the injection molding machine.

In accordance with another aspect of the invention there is provided a pre-assembled mold having a plurality of modules interconnected to form a unitary mold for use in an injection molding machine. The injection molding machine and the mold interface through standardized injection and ejection interfaces. The plurality of interconnected modules includes at least a first mold module defining a first portion of a mold chamber and a second mold module defining a second portion of the mold chamber. The mold may also include a support module for supporting at least one of the first mold module and the second mold module. The mold may also include a return housing module containing integral ejector components that are actuated by an active ejection mechanism in the ejection molding machine. The ejection mechanism may be coupled to the integral ejector components through a quick-connect mechanism, in which case the injection molding machine may include a first portion of the quick-connect mechanism and the mold may include a second portion of the quick-connect mechanism. The mold may include a clamping module for locking the mold into the injection molding machine, the clamping module including the second portion.

In accordance with another aspect of the invention there is provided an injection molding method involving providing a pre-assembled modular mold; securing the mold in an injection molding machine; injecting at least one material into the mold to form a molded part; and ejecting the molded part from the mold. The injection molding machine and the mold interface through standardized injection and ejection interfaces. A quick-connect mechanism may be used to couple an active ejection mechanism of the injection molding machine with integral ejector components of the mold. The injection molding machine may include a first portion of the quick-connect mechanism, and the mold may include a second portion of the quick-connect mechanism. Securing the mold in the injection molding machine may involve aligning the first portion and the second portion. The first portion may include a male part, and the second portion may include a female part that engages the male part, in which case securing the mold in the injection molding machine may involve aligning the female part with the male part.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the accompanying drawings:

FIG. 1 is a schematic diagram showing exemplary ejection molding apparatus in accordance with an embodiment of the present invention;

FIG. 2 is a schematic diagram showing the ejection molding apparatus of FIG. 1 installed into an injection molding machine in accordance with an embodiment of the present invention;

FIG. 3 is a schematic diagram showing a first exploded view of an exemplary mold base in accordance with an embodiment of the present invention;

FIG. 4 is a schematic diagram showing a second exploded view of an exemplary mold base in accordance with an embodiment of the present invention;

FIG. 5 is a schematic diagram showing a first perspective view of an assembled mold base in accordance with an embodiment of the present invention;

FIG. 6 is a schematic diagram showing a second perspective view of an assembled mold base in accordance with an embodiment of the present invention;

FIG. 7A is a schematic diagram showing a first exploded view of an exemplary modular mold in accordance with an embodiment of the present invention;

FIG. 7B is a schematic diagram showing a second exploded view of an exemplary modular mold in accordance with an embodiment of the present invention;

FIG. 8 is a schematic diagram showing a first perspective view of an assembled modular mold in accordance with an embodiment of the present invention;

FIG. 9 is a schematic diagram showing a second perspective view of an assembled modular mold in accordance with an embodiment of the present invention;

FIG. 10 is a schematic diagram showing the mold being lowered into the mold base for installation, in accordance with an embodiment of the present invention;

FIG. 11 is a schematic diagram showing the mold in position for installation, in accordance with an embodiment of the present invention;

FIG. 12 is an enlarged view of a portion of FIG. 11 showing the alignment of the female part with the male part in accordance with an embodiment of the present invention;

FIG. 13 is a schematic diagram showing the mold locked onto the ejector clamp plate in accordance with an embodiment of the present invention;

FIG. 14 is schematic diagram of an exemplary male part in accordance with an embodiment of the present invention;

FIG. 15 is a first perspective view of the male part in accordance with an embodiment of the present invention;

FIG. 16 is a second perspective view of the male part in accordance with an embodiment of the present invention;

FIG. 17 is a schematic diagram showing a cross-sectional view of an exemplary female part in accordance with an embodiment of the present invention;

FIG. 18 is a schematic diagram showing a front view of an exemplary female part in accordance with an embodiment of the present invention;

FIG. 19 is a schematic diagram showing a cross-sectional view of the female part aligned with the male part in an unlocked position, in accordance with an embodiment of the present invention;

FIG. 20 is a schematic diagram showing a perspective view of the male part and the female part aligned in an unlocked position;

FIG. 21 is a schematic diagram showing a cross-sectional view of the female part and the male part in a locked position, in accordance with an embodiment of the present invention;

FIG. 22 is a schematic diagram showing a first perspective view of the female part and the male part in a locked position, in accordance with an embodiment of the present invention;

FIG. 23 is a schematic diagram showing a second perspective view of the female part and the male part in a locked position, in accordance with an embodiment of the present invention;

FIG. 24 is a schematic diagram showing a first perspective view of the quick-connect mechanism with the ejection actuator in a deployed position, in accordance with an embodiment of the present invention;

FIG. 25 is a schematic diagram showing a second perspective view of the quick-connect mechanism with the ejection actuator is a deployed position, in accordance with an embodiment of the present invention.

FIG. 26 is a schematic diagram showing a first perspective view of the mold base in an open position with two molds locked onto the ejector clamp plate, in accordance with an embodiment of the present invention;

FIG. 27 is a schematic diagram showing a second perspective view of the mold base in an open position with two molds locked onto the ejector clamp plate, in accordance with an embodiment of the present invention;

FIG. 28 is a schematic diagram showing a side view of the mold base in a closed position with two molds locked onto the ejector clamp plate, in accordance with an embodiment of the present invention;

FIG. 29 is a schematic diagram showing a perspective view of the mold base in a closed position with two molds locked onto the ejector clamp plate, in accordance with an embodiment of the present invention;

FIG. 30 is a schematic diagram showing a perspective view of the mold base in a closed position with one mold locked onto the ejector clamp plate and the second mold omitted to show the male part, in accordance with an embodiment of the present invention;

FIG. 31 is a schematic diagram showing a first perspective view of the ejection mechanism positioned off-center and aligned with the molding chamber in accordance with an embodiment of the present invention;

FIG. 32 is a schematic diagram showing a second perspective view of the ejection mechanism positioned off-center and aligned with the molding chamber in accordance with an embodiment of the present invention;

FIG. 33 is a schematic diagram showing a cross-sectional view of the mold and mold base with the quick-connect mechanism engaged, in accordance with an embodiment of the present invention; and

FIG. 34 is a schematic diagram showing an enlarged view of the engaged quick-connect mechanism shown in FIG. 33.

### DETAILED DESCRIPTION OF A PREFERRED EMBODIMENT

In accordance with embodiments of the present invention, an injection molding system includes an injection molding machine that receives, or is outfitted to receive, one or more full-assembled injection molds. The injection molding machine typically includes an injection mechanism for injecting one or more materials into the mold and an ejection mechanism for ejecting a molded part from the mold. The molds preferably interface with the injection mechanism of the injection molding machine through a runner clamp plate that includes a runner system for conveying injection molding material to the mold and with the ejection mechanism of the injection molding machine through an ejector clamp plate. The runner clamp plate and the ejector clamp plate can be integral components of the injection molding machine or can be separate components that are attached or otherwise installed in the injection molding machine. The runner clamp plate and the ejector clamp plate are preferably “universal” in that they can interface with molds having different internal geometries and include standard runner and ejection interfaces between the injection molding machine and the molds.

In preferred embodiments of the present invention, a universal mold base, including the runner clamp plate and the ejector clamp plate, is installed into the injection molding machine for receiving molds. The runner clamp plate is typically attached to a fixed machine plate of the injection molding machine, and the ejector clamp plate is typically attached to a movable machine plate of the injection molding machine. The mold base can be configured to support one or more molds at a time. For example, the mold base can be configured to support one, two, four, or eight molds simultaneously. When installed into the injection molding machine, the mold base can be considered part of the machine as opposed to part of the mold.

In preferred embodiments of the present invention, the molds are modular, and include a series of interconnected modules or plates. In a typical configuration, each mold includes, in order, a cavity block that interfaces with the runner clamp plate and includes various geometry-dependent components for the molded part, a core block that includes additional geometry-dependent components for the molded part, a support plate to provide added stiffness to the core block, a return housing plate that includes components for ejecting the molded part, and a clamping plate that interfaces with the ejector clamp plate.

In preferred embodiments of the present invention, a quick-connect mechanism is used to couple the ejector components of the mold to an ejector component of the ejector clamp plate (described below). The quick-connect mechanism typically includes an elongated (male) part that is attached or integral to the ejector clamp plate and a corresponding receptacle (female) part that is attached or integral to the mold, and, more specifically, to the clamping plate of the mold. The female part is coupled to the ejector components in the mold (typically an ejector plate) for deploying and retracting the ejector components, specifically in response to movement of the male part by the injection molding machine. The female part typically includes a positive locking mechanism that interfaces with a corresponding notch or channel in the male part, so that the mold locks onto the ejector clamp plate when the male and female parts interface with one another. The quick-connect mechanism typically includes a floating mechanism that allows for movement of the mold relative to the ejector clamp plate within predetermined tolerances when the mold is locked onto the ejector clamp plate (e.g., to aid in aligning the mold with the runner clamp plate). The quick-connect mechanism typically includes an automatic release for releasing the male part from the female part following retraction of the ejector components. Once the mold is positioned onto the ejector clamp plate, the mold is typically secured with a number of bolts.

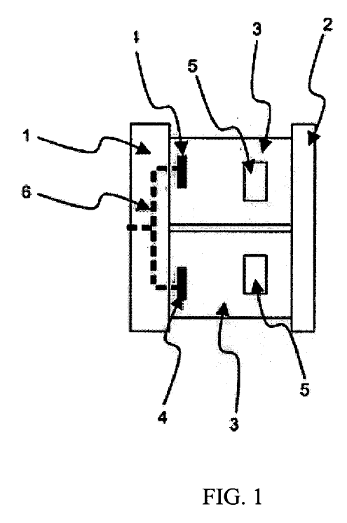

FIG. 1 is a schematic diagram showing exemplary ejection molding apparatus in accordance with an embodiment of the present invention. In this example, two molds 3 are installed between the runner clamp plate 1 and the ejector clamp plate 2. The runner clamp plate 1 includes a runner system 6 for conveying injection molding material to the molds 3. Each mold 3 includes a cavity 4 coupled to receive injection molding material from the runner system 6, and also includes an ejector mechanism 5 that is activated through the ejector clamp plate 2. As discussed above, the runner clamp plate 1 and the ejector clamp plate 2 can be components of the injection molding machine or can be separate components that are attached or otherwise installed in the injection molding machine. For example, the runner clamp plate 1 and the ejector clamp plate 2 can be components of a mold base that is installed into the injection molding machine.

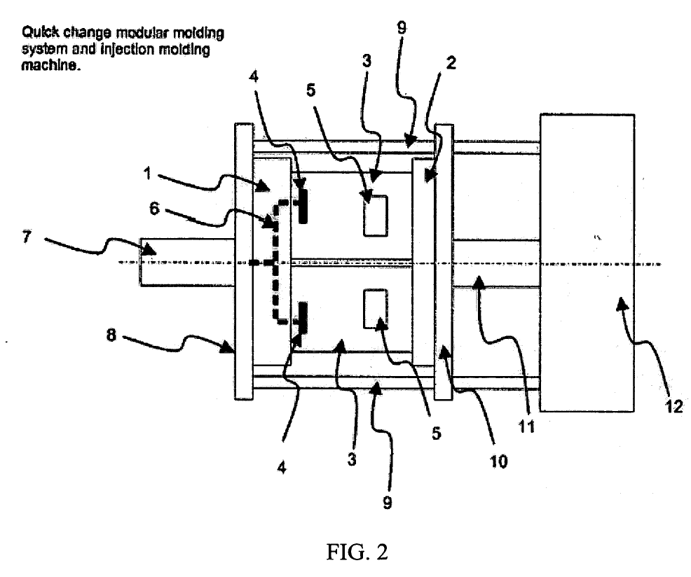

FIG. 2 is a schematic diagram showing the ejection molding apparatus of FIG. 1 installed into an injection molding machine in accordance with an embodiment of the present invention. The runner clamp plate 1 is attached to a fixed machine plate 8 of the injection molding machine. The ejector clamp plate 2 is attached to a movable machine plate 10 of the injection molding machine. After the molds 3 are installed onto the ejector clamp plate 2, the molds 3 are moved into contact with the runner clamp plate 1 by cylinder 11 that is attached to machine base 12. Injection molding material can then be introduced to the molds 3 through machine injection unit 7.

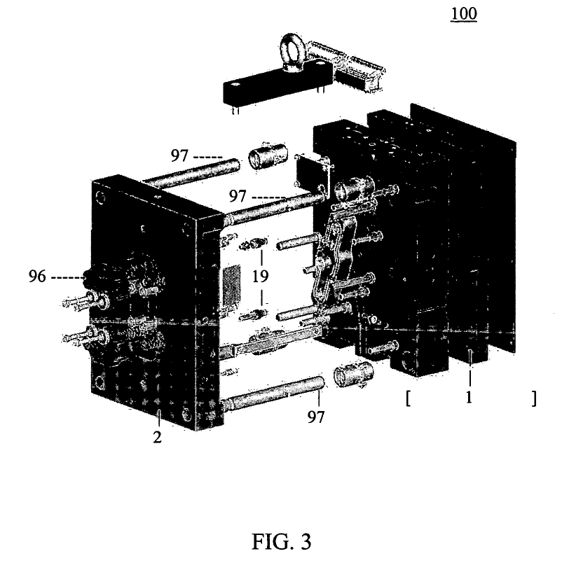

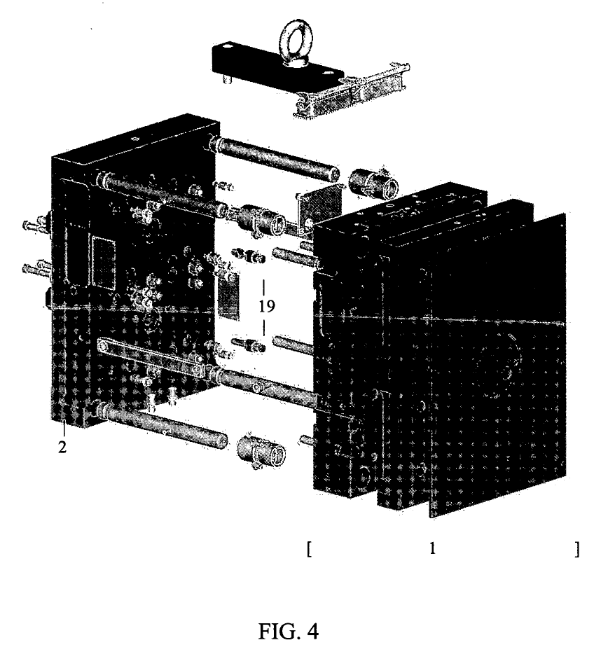

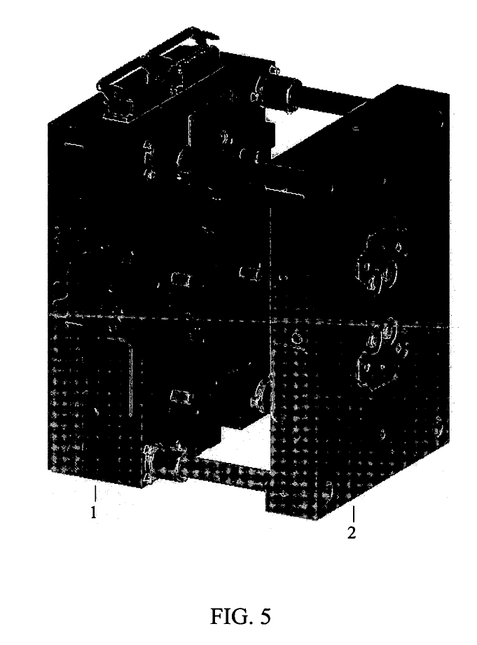

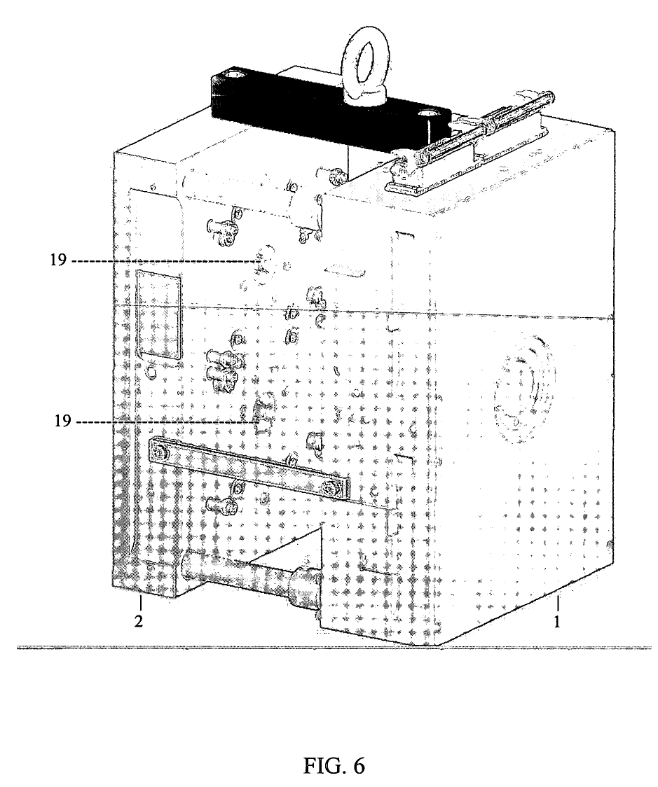

As discussed above, in preferred embodiments of the present invention, the runner clamp plate 1 and the ejector clamp plate 2 are components of a mold base that is installed into the injection molding machine. FIG. 3 is a first exploded view of an exemplary mold base 100 in accordance with an embodiment of the present invention. Among other things, the mold base 100 includes runner clamp plate 1 and ejector clamp plate 2. The runner clamp plate 1 is typically mounted to a fixed plate of the injection molding machine, while the ejector claim plate 2 is typically mounted to a movable plate of the injection molding machine. The ejector clamp plate 2 is allowed to move relative to the runner clamp plate 1 along rails 97. In this example, the ejector clamp plate 2 is configured to support two molds, and therefore the ejector clamp plate 2 includes two male parts 19 (described in more detail below). The male parts 19 are coupled to an ejection mechanism interface 96 through which the male parts 19 are operated by the injection molding machine. FIG. 4 is a second exploded view of an exemplary mold base 100 in accordance with an embodiment of the present invention. FIG. 5 is a first perspective view of an assembled mold base 100 in accordance with an embodiment of the present invention. FIG. 6 is a second perspective view of an assembled mold base 100 in accordance with an embodiment of the present invention.

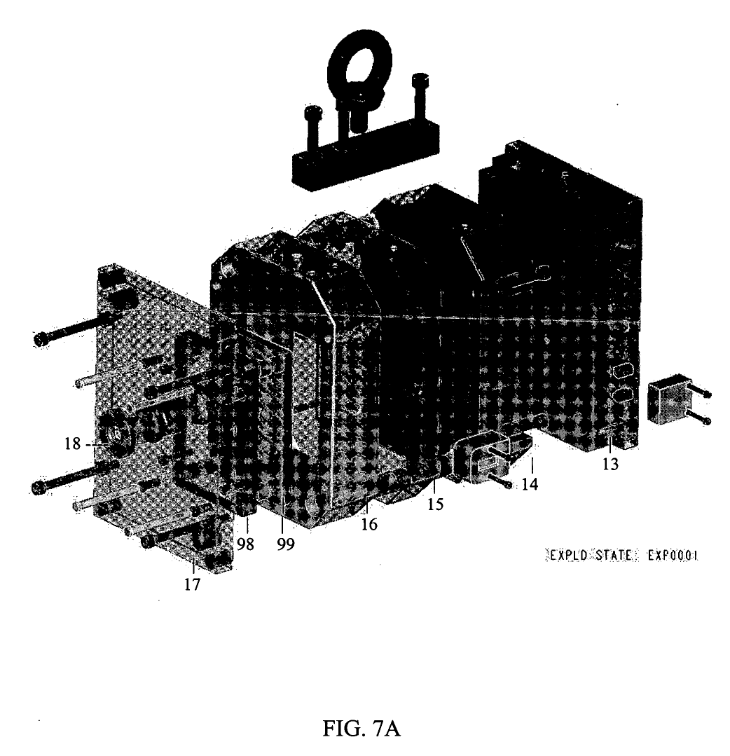

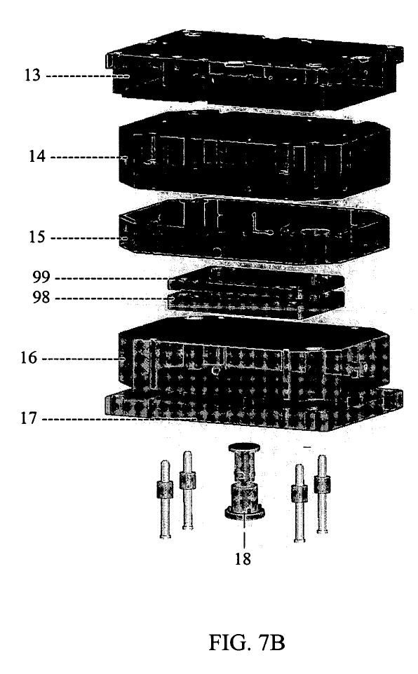

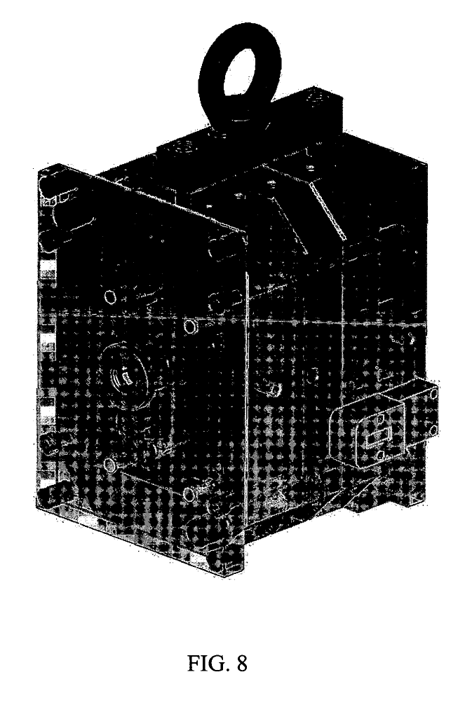

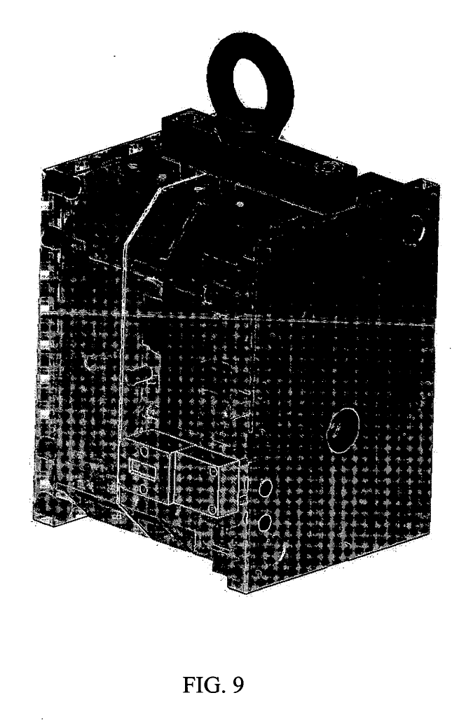

As discussed above, in preferred embodiments of the present invention, the molds are modular, and include a series of interconnected modules or plates. The molds are preferably pre-assembled so that the unitary mold can be placed into the mold base. Among other things, such pre-assembly helps to reduce the likelihood of damage to the mold components and the likelihood of omitting a mold component. FIG. 7A is a schematic diagram showing a first exploded view of an exemplary modular mold 3 in accordance with an embodiment of the present invention. Among other things, the mold 3 includes a cavity block 13 that interfaces with the runner clamp plate 1 and includes various geometry-dependent components for the molded part; a core block 14 that includes additional geometry-dependent components for the molded part; a support plate 15 to provide added stiffness to the core block 14; a return housing plate 16 that contains components for ejecting the molded part, including a retainer plate 99 and an ejector plate 98; and a clamping plate 17 that interfaces with the ejector clamp plate 2. The clamping plate 17 includes a receptor (female) part 18 for the quick-connect mechanism. The female part 18 is coupled to the ejector plate 98 for actuating the ejection mechanism. FIG. 7B is a schematic diagram showing a second exploded view of an exemplary modular mold 3 in accordance with an embodiment of the present invention. FIG. 8 is a schematic diagram showing a first perspective view of an assembled modular mold in accordance with an embodiment of the present invention. FIG. 9 is a schematic diagram showing a second perspective view of an assembled modular mold in accordance with an embodiment of the present invention.

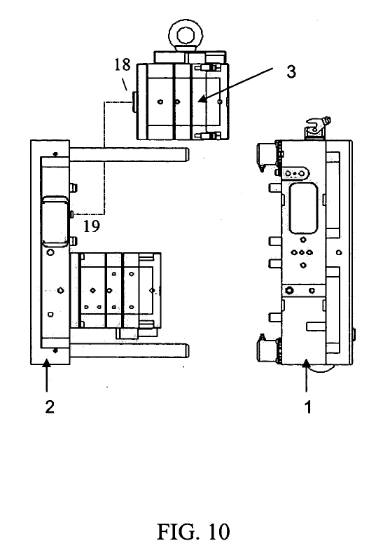

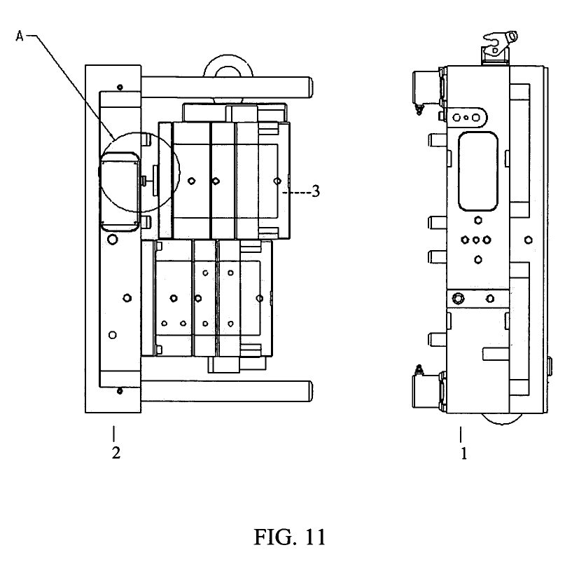

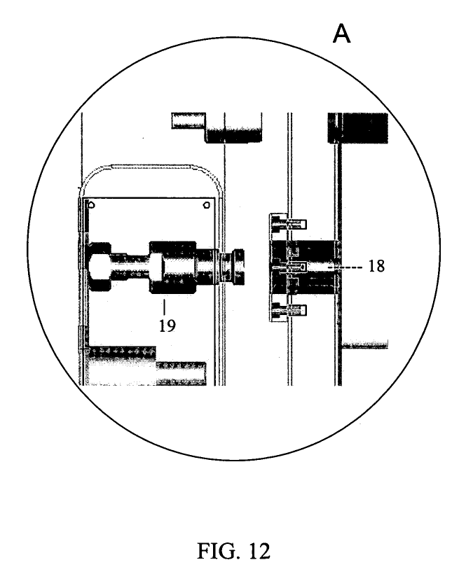

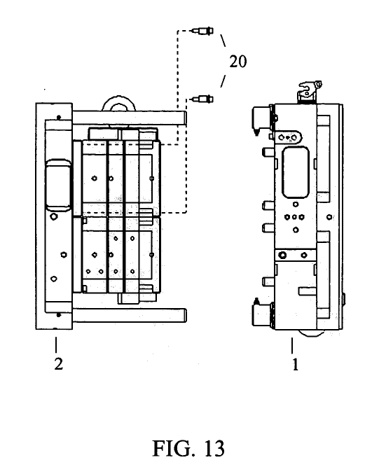

The procedure for installing a mold into the mold base is now described. FIG. 10 is a schematic diagram showing the mold 3 being lowered into the mold base for installation, in accordance with an embodiment of the present invention. The ejector clamp plate 2 includes a male part 19 of the quick-connect mechanism and the mold 3 includes the corresponding female part 18 of the quick-connect mechanism. In this example, the mold 3 will be installed above another, previously installed, mold. FIG. 11 is a schematic diagram showing the mold 3 in position for installation, in accordance with an embodiment of the present invention. The female part 18 of the mold 3 is aligned with the male part 19 of the ejector clamp plate 2. FIG. 12 is an enlarged view of a portion of FIG. 11 showing the alignment of the female part 18 with the male part 19. FIG. 13 is a schematic diagram showing the mold 3 locked onto the ejector clamp plate 2. Once the mold 3 is positioned onto the ejector clamp plate 2, bolts 20 are used to secure the mold 3 to the ejector clamp plate 2.

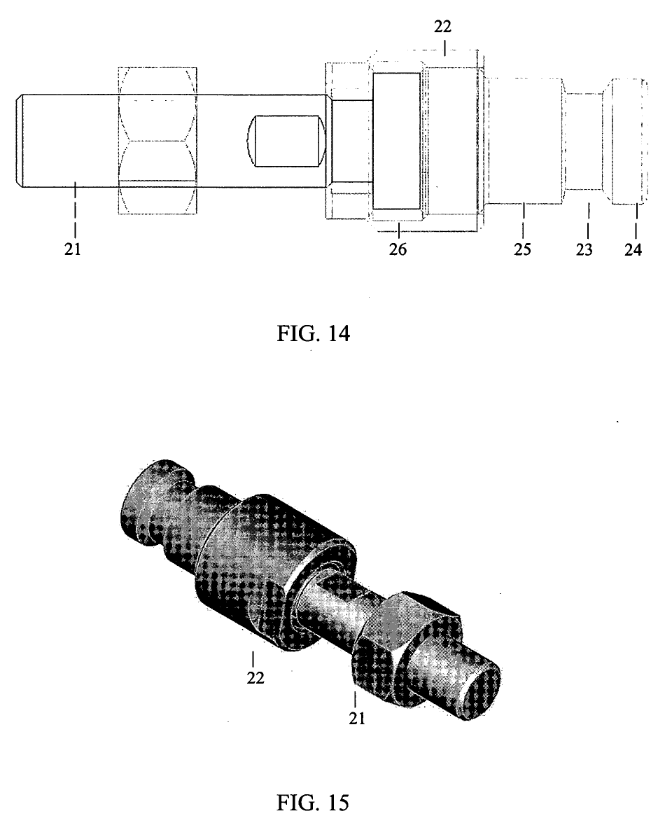

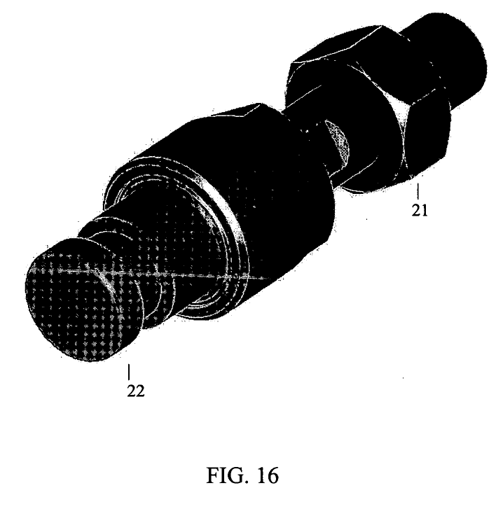

The male part 19 of an exemplary quick-connect mechanism is now described. FIG. 14 is schematic diagram of an exemplary male part 19 in accordance with an embodiment of the present invention. Among other things, the male part 19 includes a bottom portion 21 and a top portion 22. The bottom portion 21 connects to the ejector clamp plate 2. The top portion 22 includes a narrowed channel 23, defined by a head 24 and a body 25, for engaging the positive locking mechanism of the female part 18. The bottom portion 21 and the top portion 22 are loosely interconnected at 26 so that the top portion 22 can move or “float” relative to the bottom portion 21, thereby allowing the mold 3 to move relative to the ejector clamp plate 2 within predetermined tolerances when the mold 3 is locked onto the ejector clamp plate 2. FIG. 15 is a first perspective view of the male part 19 in accordance with an embodiment of the present invention. FIG. 16 is a second perspective view of the male part 19 in accordance with an embodiment of the present invention.

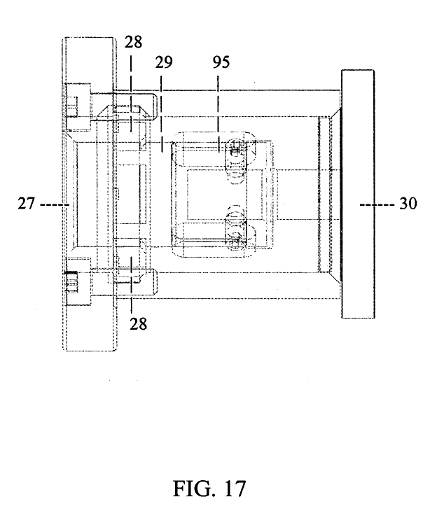

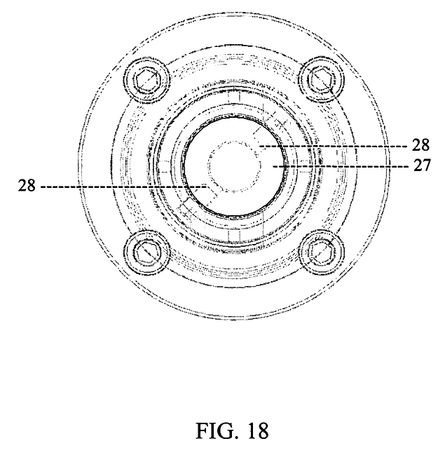

The female part of an exemplary quick-connect mechanism is now described. FIG. 17 is a schematic diagram showing a cross-sectional view of an exemplary female part 18 in accordance with an embodiment of the present invention. Among other things, the female part 18 includes an opening 27 for receiving the top portion 22 of the male part 19, positive locking posts 28 for engaging the narrowed channel 23 of the male part 19, and an ejector component interface 95 that is further acted upon by the male part 19 to deploy and retract ejection actuator 30. When the male part 19 is locked into the female part 18 such that the positive locking posts 27 engage the narrowed channel 23, the head 24 of the top portion 22 is received within chamber 29 in contact with ejector component interface 95. The ejection actuator 30 is coupled to the ejector plate in the mold, and is used to deploy and retract the ejector plate for ejecting the molded part from the mold. FIG. 18 is a schematic diagram showing a front view of an exemplary female part 18 in accordance with an embodiment of the present invention. In preferred embodiments of the present invention, the female part 18 is a return device that is commercially available from H. Müller Mekaniska AB of Borås, Sweden.

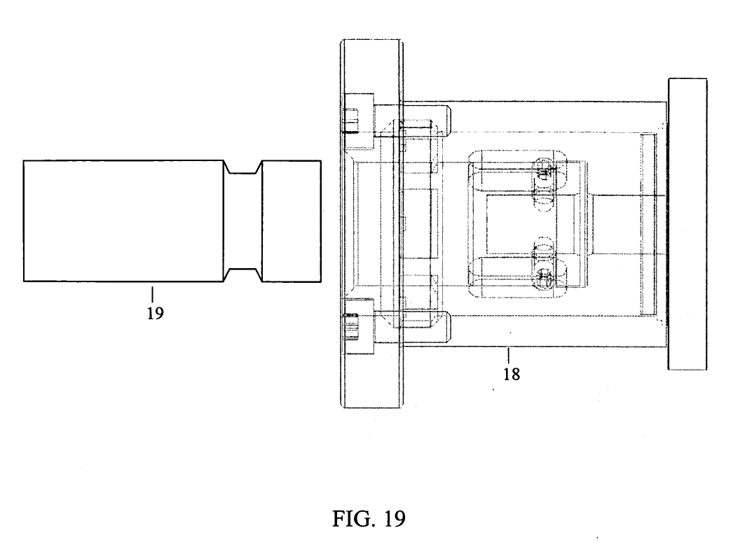

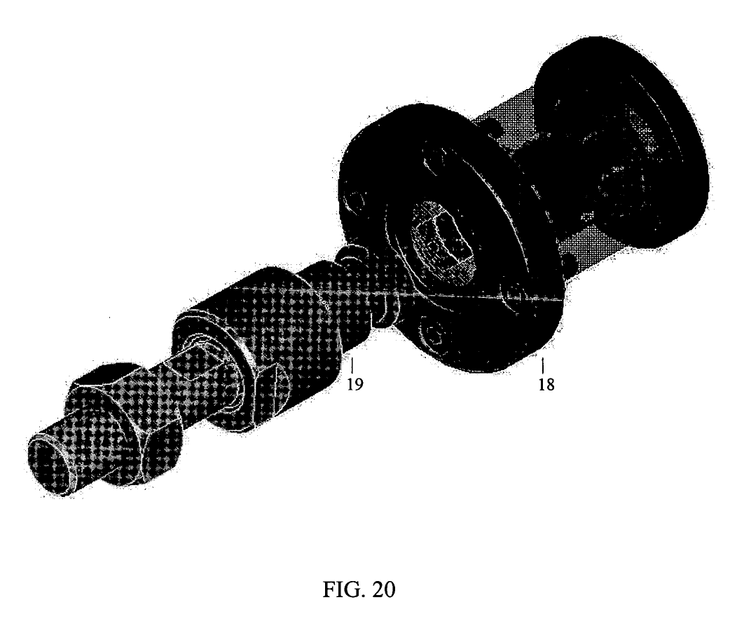

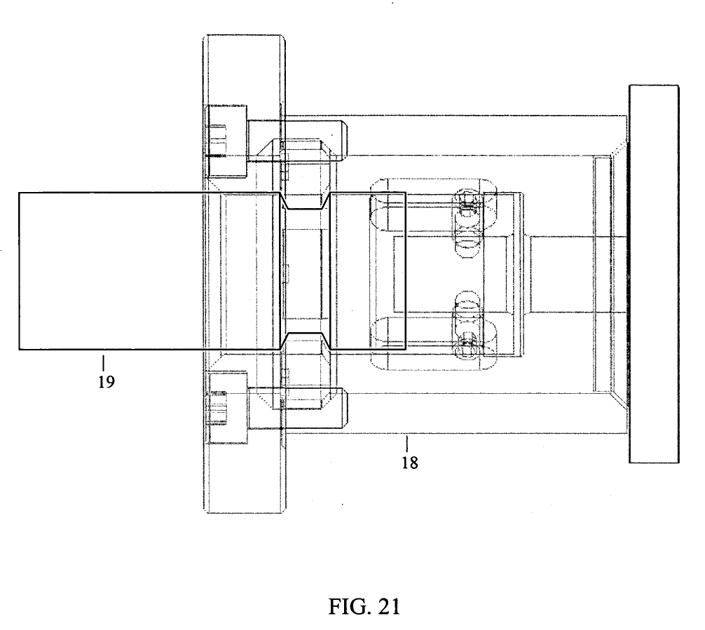

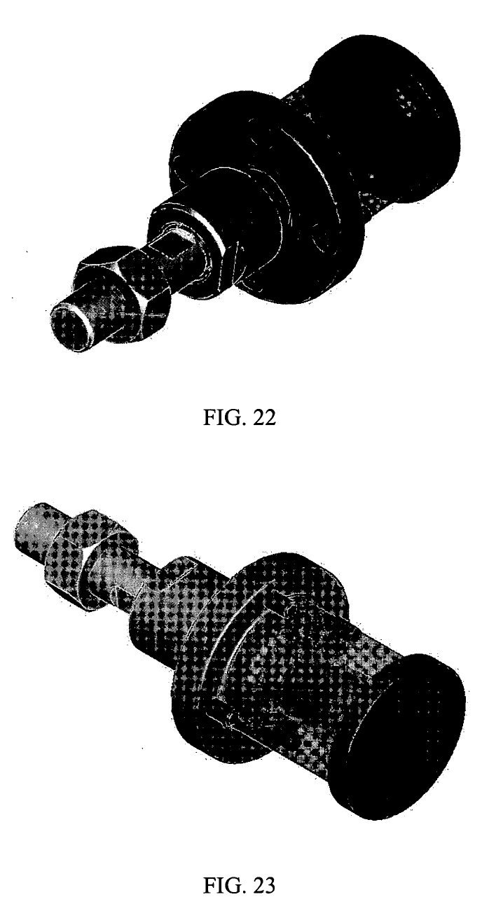

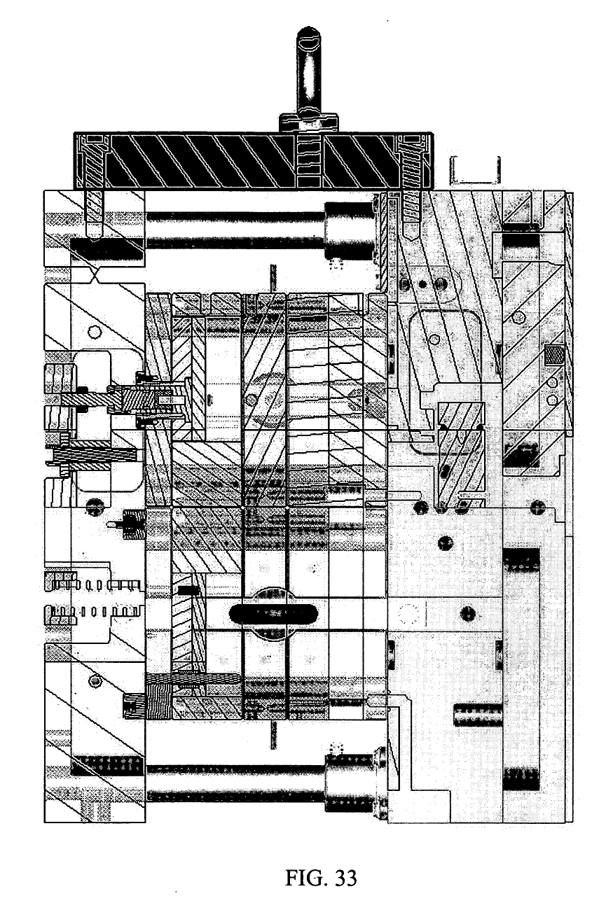

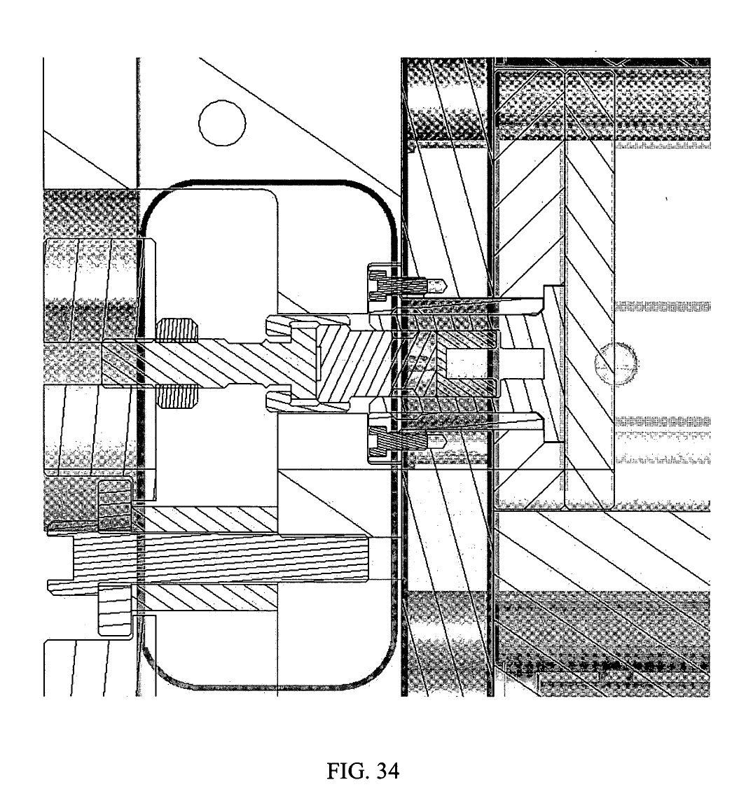

In order to lock the ejector mechanism of the injection molding machine with the internal ejector components of the mold 3, the male part 19 is engaged with the female part 18. FIG. 19 is a schematic diagram showing a cross-sectional view of the female part 18 aligned with the male part 19 (and, more particularly, with the top portion 22 of the male part 19) in an unlocked position, in accordance with an embodiment of the present invention. FIG. 20 is a schematic diagram showing a perspective view of the male part 19 and the female part 18 aligned in an unlocked position. FIG. 21 is a schematic diagram showing a cross-sectional view of the female part 18 and the male part 19 in a locked position, in accordance with an embodiment of the present invention. FIG. 22 is a schematic diagram showing a first perspective view of the female part 18 and the male part 19 in a locked position, in accordance with an embodiment of the present invention. FIG. 23 is a schematic diagram showing a second perspective view of the female part 18 and the male part 19 in a locked position, in accordance with an embodiment of the present invention. FIG. 33 is a schematic diagram showing a cross-sectional view of the mold and mold base with the quick-connect mechanism engaged, in accordance with an embodiment of the present invention. FIG. 34 is a schematic diagram showing an enlarged view of the engaged quick-connect mechanism shown in FIG. 33.

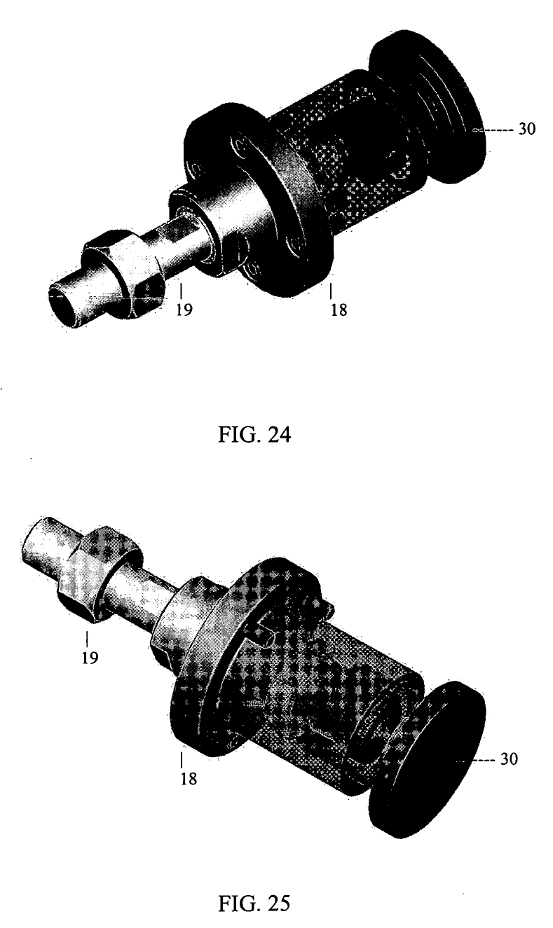

In order to eject the molded part from the mold 3, the male part 19 is pushed forward by the ejection mechanism of the injection molding machine, which in turn causes deployment of the ejection actuator 30 via the ejector component interface 95. FIG. 24 is a schematic diagram showing a first perspective view of the quick-connect mechanism with the ejection actuator 30 in a deployed position, in accordance with an embodiment of the present invention. FIG. 25 is a schematic diagram showing a second perspective view of the quick-connect mechanism with the ejection actuator 30 is a deployed position, in accordance with an embodiment of the present invention. When the male part 19 is retracted by the ejection mechanism of the injection molding machine, the positive locking feature of the female part 18 causes the ejection actuator 30 to be retracted, thereby retracting the ejection plate in the mold. The female part 18 typically released the male part 19 automatically when the male 19 is fully retracted.

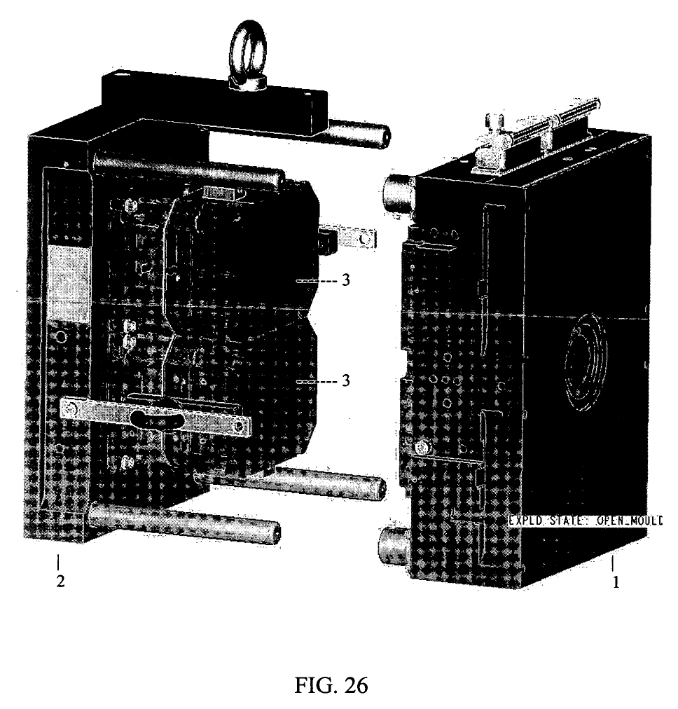

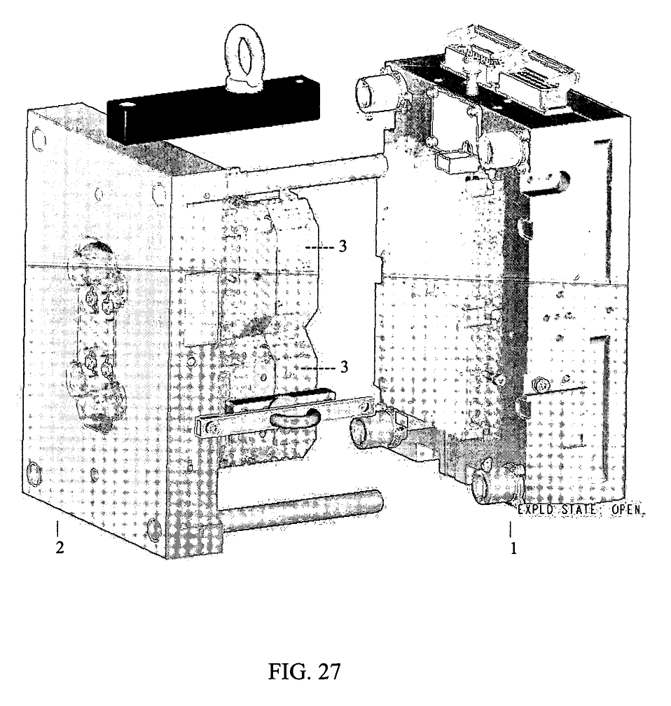

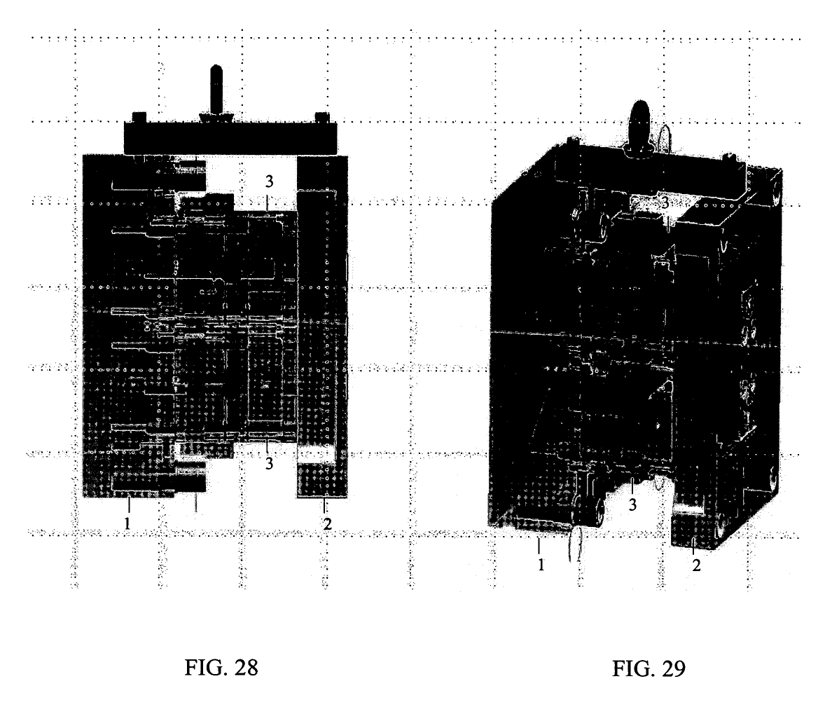

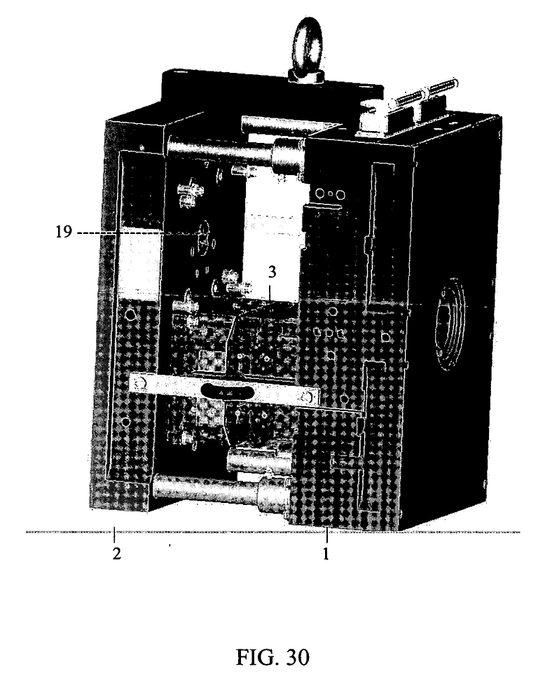

As discussed above, the runner clamp plate 1 and the ejector clamp plate 2 (and therefore the mold base 100) can be configured to support one, two, or more molds. FIGS. 26-30 show additional details of an injection molding system in accordance with an exemplary embodiment of the present invention in which the mold base 100 is configured to support two molds. FIG. 26 is a schematic diagram showing a first perspective view of the mold base 100 in an open position with two molds 3 locked onto the ejector clamp plate 2, in accordance with an embodiment of the present invention. FIG. 27 is a schematic diagram showing a second perspective view of the mold base 100 in an open position with two molds 3 locked onto the ejector clamp plate 2, in accordance with an embodiment of the present invention. FIG. 28 is a schematic diagram showing a side view of the mold base 100 in a closed position with two molds 3 locked onto the ejector clamp plate 2, in accordance with an embodiment of the present invention. FIG. 29 is a schematic diagram showing a perspective view of the mold base 100 in a closed position with two molds 3 locked onto the ejector clamp plate 2, in accordance with an embodiment of the present invention. FIG. 30 is a schematic diagram showing a perspective view of the mold base 100 in a closed position with one mold 3 locked onto the ejector clamp plate 2 and the second mold omitted to show the male part 19, in accordance with an embodiment of the present invention.

After the molds are installed in the injection molding machine, the molding material can be injected into the molds. The material is allowed to set for some period of time, after which the molded parts are ejected from the molds. This is typically accomplished through hydraulic operation of the male parts 19. Specifically, with reference again to FIGS. 3 and 17, the injection molding machine includes a hydraulically-operated injection mechanism that forces the ejection mechanism interface 96 toward the ejector clamp plate 2 and hence forces the male part 19 to extend outward from the ejector clamp plate 2. The extended male part 19 in turn act upon the ejector component interface 95 of the female part 18 to deploy the ejection actuator 30 to actuate the ejector components of the mold.

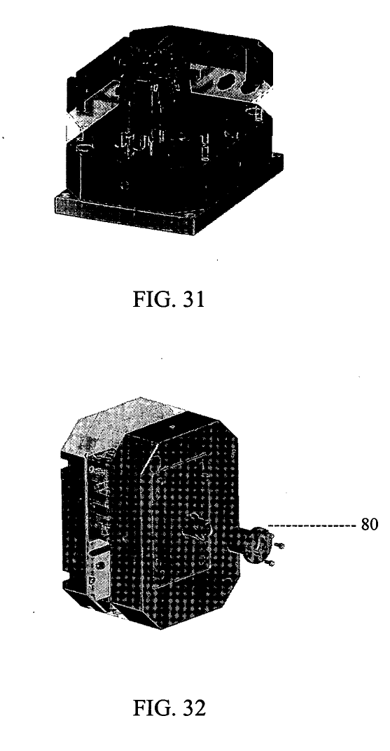

One general problem in injection molding systems is deformation of the mold caused by the force of the material as it is being injected. Such deformation typically depends on, in part, the size and placement of the opening of the ejection mechanism located in the return housing plate 16. Therefore, in preferred embodiments of the present invention, the molding chamber(s) and related components, such as the ejection mechanism in the return housing plate 16, are placed off-center and are substantially aligned. This alignment of the ejection mechanism with the molding chamber(s) generally allows the size of the opening to be reduced, which in turn helps to reduce the amount of deformation during injection molding. FIG. 31 is a schematic diagram showing a first perspective view of the ejection mechanism positioned off-center and aligned with the molding chamber. FIG. 32 is a schematic diagram showing a second perspective view of the ejection mechanism positioned off-center and aligned with the molding chamber. The ejector plate of the ejection mechanism is preferably snapped into place without the use of tools.

It should be noted that, while the portions of the quick-connect mechanism are preferably located on clamping plate and the ejector clamp plate, alternatively the portions of the quick-connect mechanism could be located elsewhere on the mold and the injection molding machine. For example, the machine portion of the quick-connect mechanism could be located on the runner clamp plate 1, in which case the mold portion of the quick-connect mechanism could be located on the cavity block 13. Thus, the present invention is not limited to the position of the portions of the quick-connect mechanism.

It should also be noted that, while preferred embodiments include one and only one quick-connect mechanism for each mold, alternatively there could be multiple quick-connect mechanisms for each mold. Thus, the present invention is not limited to a particular number of quick-connect mechanisms for each mold.

The present invention may be embodied in other specific forms without departing from the true scope of the invention. The described embodiments are to be considered in all respects only as illustrative and not restrictive.

What is claimed is:

1. An injection molding system comprising:
an injection molding machine; and
a modular mold that is assembled prior to installation in the injection molding machine, wherein the injection molding machine and the mold interface through standardized injection and ejection interfaces.

2. An injection molding system according to claim 1, wherein:
the injection molding machine includes an active ejection mechanism;
the mold includes integral ejector components actuated by the ejection mechanism; and
the ejection mechanism is coupled to the integral ejector components through a quick-connect mechanism.

3. An injection molding system according to claim 2, wherein the injection molding machine includes a first portion of the quick-connect mechanism, and wherein the mold includes a second portion of the quick-connect mechanism.

4. An injection molding system according to claim 3, wherein the injection molding machine includes an ejector clamp plate that includes the first portion.

5. An injection molding system according to claim 3, wherein the mold includes a clamping plate that includes the second portion.

6. An injection molding system according to claim 3, wherein the first portion comprises a male part, and wherein the second portion comprises a female part that engages the male part.

7. An injection molding system according to claim 6, wherein the female part includes a positive locking feature for securing the male part during deployment and retraction of the integral ejector components.

8. An injection molding system according to claim 6, wherein the male part includes a floating mechanism allowing the mold to move relative to the injection molding machine when the mold is locked into the injection molding machine.

9. An injection molding machine configured to receive a pre-assembled modular mold, the injection molding machine and the mold interfacing through standardized injection and ejection interfaces.

10. An injection molding machine according to claim 9, wherein the injection molding machine includes an active ejection mechanism that is coupled to integral ejector components of the mold through a quick-connect mechanism.

11. An injection molding machine according to claim 10, wherein the injection molding machine includes a first portion of the quick-connect mechanism for cooperation with a second portion of the quick-connect mechanism in the mold.

12. An injection molding machine according to claim 11, wherein the injection molding machine includes an ejector clamp plate that includes the first portion.

13. An injection molding machine according to claim 11, wherein the first portion comprises a male part, and wherein the second portion comprises a female part that engages the male part.

14. An injection molding machine according to claim 13, wherein the male part is positively locked into the female part for deployment and retraction of the integral ejector components.

15. An injection molding machine according to claim 13, wherein the male part includes a floating mechanism allowing the mold to move relative to the injection molding machine when the mold is locked into the injection molding machine.

16. Apparatus for use in an injection molding system, the apparatus comprising:
a plate attachable to an injection molding machine for interfacing the injection molding machine with a pre-assembled modular mold, the plate and the mold interfacing through a standardized ejection interface.

17. Apparatus according to claim 16, wherein the standardized ejection interface includes a quick-connect mechanism for coupling an active ejection mechanism of the injection molding machine with integral injector components in the mold.

18. Apparatus according to claim 17, wherein the plate includes a first portion of the quick-connect mechanism for cooperation with a second portion of the quick-connect mechanism in the mold.

19. Apparatus according to claim 18, wherein the first portion comprises a male part, and wherein the second portion comprises a female part that engages the male part.

20. Apparatus according to claim 19, wherein the male part is positively locked into the female part for deployment and retraction of the integral ejector components.

21. Apparatus according to claim 19, wherein the male part includes a floating mechanism allowing the mold to move relative to the injection molding machine when the mold is locked into the injection molding machine.

22. Apparatus comprising:
a plurality of interconnected modules pre-assembled to form a unitary mold for use in an injection molding machine, the injection molding machine and the mold interfacing through standardized injection and ejection interfaces, the plurality of interconnected modules including at least a first mold module defining a first portion of a mold chamber and a second mold module defining a second portion of the mold chamber.

23. Apparatus according to claim 22, wherein the plurality of interconnected modules further includes a support module for supporting at least one of the first mold module and the second mold module.

24. Apparatus according to claim 23, wherein the plurality of interconnected modules further includes a return housing module containing integral ejector components that are actuated by an active ejection mechanism in the ejection molding machine.

25. Apparatus according to claim 24, wherein the ejection mechanism is coupled to the integral ejector components through a quick-connect mechanism.

26. Apparatus according to claim 25, wherein the injection molding machine includes a first portion of the quick-connect mechanism, and wherein the mold includes a second portion of the quick-connect mechanism.

27. Apparatus according to claim 26, wherein the plurality of interconnected modules further includes a clamping module for locking the mold into the injection molding machine, the clamping module including the second portion.

28. Apparatus according to claim 26, wherein the first portion comprises a male part, and wherein the second portion comprises a female part that engages the male part.

29. Apparatus according to claim 28, wherein the female part includes a positive locking feature for securing the male part during deployment and retraction of the integral ejector components.

30. An injection molding method comprising:
providing a pre-assembled modular mold;
securing the mold in an injection molding machine;
injecting at least one material into the mold to form a molded part; and
ejecting the molded part from the mold.

31. An injection molding method according to claim 30, wherein the injection molding machine and the mold interface through standardized injection and ejection interfaces.

32. An injection molding method according to claim 31, wherein:
the injection molding machine includes an active ejection mechanism;
the mold includes integral ejector components actuated by the ejection mechanism; and
the ejection mechanism is coupled to the integral ejector components through a quick-connect mechanism.

33. An injection molding method according to claim 32, wherein the injection molding machine includes a first portion of the quick-connect mechanism, and wherein the mold includes a second portion of the quick-connect mechanism.

34. An injection molding method according to claim 33, wherein securing the mold in the injection molding machine involves aligning the first portion and the second portion.

35. An injection molding method according to claim 33, wherein the first portion comprises a male part, and wherein the second portion comprises a female part that engages the male part.

36. An injection molding method according to claim 35, wherein securing the mold in the injection molding machine involves aligning the female part with the male part.
